(19) United States
(12) Patent Application Publication
(10) Pub. No.: US 2001/0007132 A1
(43) Pub. Date: Jul. 5, 2001

(54) CLT (Close Loop Transaction)

(76) Inventor: Eyal Regev, Alfe-Menashe (IL)

Correspondence Address: Eyal Regev, 83, Arbel St., Alfe-Menashe, 44851, IL

(21) Appl. No.: 09/729,308

(22) Filed: Dec. 5, 2000

(30) Foreign Application Priority Data
Dec. 28, 1999 (IL) 133771

(51) Int. Cl. H04L 12/22

(52) U.S. Cl. 713/201; 380/33

(57) ABSTRACT

In a network communications system involving a Customer, a Retailer and a acquirer (for example credit-card provider). The method includes a six step procedure for providing a secure way of making network transactions, by providing complete isolation between the customer's full details, needed to complete a transaction, and the retailer or any other third side trying to get access to them by splitting this information to two parts, each transferred in a sperate line of transmission, one between the customer-retailer and the second between the customer and the credit card provider, and when one of them includes initiated response to the consumer, by the acquirer. By doing so living the sole control of data in the acquirers (for example Issuer) secured server.

### BACKGROUND OF THE INVENTION

Currently, there are three major Secure Electronic Transaction (SET) payment schemes, which have been developed and implemented. Each of these schemes utilizes cryptography for the purpose of providing confidentiality of information, ensuring payment integrity, and authenticating both merchants and cardholders. These security criteria are provided in hopes of enabling greater bank card acceptance combined with a level of security that will encourage consumers and businesses to make wide use of bank card products in this emerging market. In particular, the three SET payment schemes can be classified as follows: payment schemes using encrypted data; payment schemes using third parties; and payments using digital cash; A brief explanation and implementation examples of each payment scheme follow.

Payments Using Encrypted Data:

With this payment scheme, credit card details are encrypted before they are transmitted to the merchant. The loading protocols used to establish the three security criteria above described are secured sockets layer “SSL” and secure HTTP “S-HTTP” which have been designed by RSA Data Security Inc. for Netscape and Enterprise Integration Technologies for NCSA Mosaic respectively. These two protocols are parallel security protocols. (Recently, a decision was announced by Netscape that both of those protocols would become integrated since they are deemed complementary.)

Specifically, SSL provides the encryption necessary to route data to the merchants server while the S-HTTP protocol provides for security at the server itself

In particular, these protocols both use public -key encryption to provide secure links. Public-key encryption uses a pair of keys whereby messages encoded by one key can only be decoded by the other key of that pair, and vice versa. Every working party has a unique set of keys where one key is kept secret, and the other key is made public. This differs from secret-key encryption which utilizes one and the same key for encoding and decoding.

By way of example, public-key encryption generally works as follows: for authentication, a party encrypts with a secret key; verification is provided by decoding using the sending party encrypts using the other party's public key. For example of this payment scheme implemented, see The Netscape Galleria.

While this scheme is advantageous since the application is transparent to the end user and it provides enhanced security, it nevertheless suffers the disadvantages of relying on codes that can be theoretically broken and is costly to implement in terms of added equipment and overhead.

Furthermore, the method sufers the disadvantage that wile creating a relative safe transmission of the data, the party at the end of the communication link referred to as retailer still has all the information needed to complete network or other (telephone for example) transactions with out the direct and specific authorization of the customer in the future. Furthermore those personal details needed for the completion of the transaction are in the danger of been transferred to the wrong hands either by negligence or as a criminal act. It is commonely believed that this problem arises the fear and avantuly the draw back from going through with network transactions. The CLT method deal's directly with this problem, and is the only one to prevent it completely.

Payments using third parties.

For payment schemes involving third parties, a company collects and approves all payments from one client to another. All the information necessary for the transaction is collected via the internet except for the confidential credit card number data. Specifically, the credit card number data is transmitted via a secure telephone line and the information is kept on a secure computer that cannot be accessed from the internet. (The third party makes money by charging the merchant and consumer for services much in the same way as conventional credit card companies make money.)

For an example of this payment scheme implemented, see First Virtual, NctChex, Cyota, Applitex, Orbiscom, Transale and the NctBill Project.

While this scheme is simple, safe and secure without requiring the use of complicated encryption techniques, there are seen to be a number of disadvantages. In particular, this scheme suffers the disadvantages of adding the cost of third-party services, allowing spending limits to be reached without the knowledge of the consumer since money is linked to a credit card, and the potential loss of privacy since all data is gathered in a centralized system.

Furthermore, problems utilizing this scheme also result from the need to manage shipping costs, backorders, delayed shipments, and billing problems arising from the involvement of the third-party.

OPEN MARKETS, offers another alternative for providing the merchant with the customer order via a highly developed and dedicated secure server. Specifically, credit card information is handled by OPEN MARKETS, through a dedicated “back-end” server hosted by OPEN MARKETS, which is linked by dedicated phone lines to a financial institution. The credit card information is not processed until OPEN MARKETS is notified by the retailer, via regular e-mail or phone, that the order has been shipped. At the time OPEN MARKETS processes the credit card information for the retailer. However, this scheme also suffers from many of the disadvantageous above-described.

In contrary to these limitations the CLT method dose not suffer the disadvantages of adding the cost of third-party service and reviling personal information to it, since it is done directly through the credit card providers server and which already consists the personal information of the customer. Furthermore all the disadvantages mentioned above such as need to manage shipping costs, backorders, delayed shipments, and billing problems arising from the involvement of the third-party do not exist for the same reason. Furthermore using the CLT method dose not require a telephone replay since it is done entirely through the WEB and therefore expenses relating to it such as the huge cost of employing people that have to phone you back, the discomfort of waiting for unknown time frames until you receive a call back, and the uncertainty of trusting the people working in those positions. On the other hand the CLT is completely computerizes and all details are controlled from the data base of the secured credit card providers computers unit, so that the process is completely automatic with out the interference of man, and by doing that, making all the money transactions done directly between the credit card provider, which also gives the insurance and the customer, and by that ensuring a safe, simple and easy to understand transaction.

Payments using Digital Cash:

This scheme uses a third party as well but differs significantly from the previously described third party scheme. In the previous third-party payment scheme, the third-party analogous to the post office, In the digital cash scheme the third-party acts as a virtual bank that provides “digital coins” to the consumer. In particular, money is deposited via a credit card over secure telephone lines or mailed in the form of a check to the virtual bank in the same manner as a conventional bank account. The consumer can then withdraw the digital coins from their internet bank account and store them on the hard drive. When a purchase is made, the money is withdrawn from the hard drive and transmitted to the merchant or another party. Smart cards can also be used to store digital coins allowing cash to be carried. The scheme of providing security for the digital coins is again RSA public-key encryption.

Specifically, when utilizing this scheme to make withdrawals from the virtual bank, the consumers PC determines the equivalent digital coin amount required by the user and produces a random serial number representative of said amount. Thereafter, the serial number is “blinded” using RSA public-key cryptography to insure privacy. The bank encodes the serial number with its own secret key (digital signature) and debits the consumers account. The digital coins are then sent back to the user and decoded using the bank public key for storage on the consumers PC. To spend the digital coins, the PC collects the amount of coins necessary to reach the requested total value of the transaction which coins are sent to the receiver. The receiver then sends the coins directly to the digital bank where the bank verifies the validity of the digital coins and credits the account of the receiver .

For an example of this payment scheme implemented, see CyberCash, Digicash, and Net Bank.

While this scheme has the advantage of providing anonymity to the consumer, quickness, and working much on the same familiar principle as cash, this scheme nevertheless suffers the disadvantage of being complicated. In addition, hardware failure can mean loss of money. As a result, this scheme has not gained widespread support from banks and merchants.

A variation to this scheme would be CYBERCASH'S “wallet” software. CYBERCASH provides a method for allowing subscribers on a networked communications system to transfer commercial information to a company subscriber in a secured manner. In particular, CYBERCASH requires a subscriber “wallet” which is a piece of software that must be downloaded or otherwise locally installed on the subscriber wishes to maintain as secure. This encrypted information is then transferred to a designated server and accordingly forwarded to the company subscriber and CYBERCASH for description. The financial institution is linked via a dedicated phone line to CYBERCASH. The credit card transaction is approved and that data is re-encrypted and returned to the subscriber and the company subscriber. The basic drawback of this scheme is primarily the additional software required by the consumer and a complicated back-end system that incorporates a third-party, CYBERCASH and a bank, plus several back and fourth transactions, all resulting in numerous file structures. This scheme suffers the further disadvantage of requiring the user to have specialized programming resident on the user's subscriber unit. From the foregoing description of available secured commercial transaction methods, it is seen that a need exists for an improvement method for providing secure commercial transactions via a network communications system.

As a result of this existing need, it is an object of the present invention to provide a method of providing secured commercial transactions via a network communication system in which consumers will have confidence.

It is a further object of the invention to provide a method that is easy, attractive, and transparent to consumers when utilized.

It is yet another object of the present invention to ensure that a complete isolation exists between the consumer's credit card data and the retailer, to ensure total control of transactions in the customer's hands.

It is yet another object of the present invention to ensure that non other transaction then the one authorized specifically by the consumer at a time will be made with their credit card.

### SUMMERY OF THE INVENTION

The method is based on the following steps hereby referred to as the “CLT 6 step's procedure” which insure complete isolation between the customer—credit-card provider channel and the customer—Retailer channel, and therefor prevent the possibility of two major risks:

The possibility that someone from the retailer's part will be able to use your credit card in order to redraw money with out your permission, or even pas it throw to a third size, with out any option for control.

The possibility of redrawing money from your credit-card account, in case that someone will be able to read the information transferred on each of the internet channel's themselves, does not exist. That is because the only link between the channel's is in the credit card provider's computer's, with out completing the transaction Loop (using the information in both channels), no one can complete a transaction. Further more, if someone will attempt using one of the channels with out being able to confirm in the other, a security warning will appear at the credit card provider, and tractability over criminals will be possible.

No known method was able to provide this level of safety, because no other method leaves total control of the transaction in the hands of the customer in the way that the only one that can potentially be able to non contently use a credit card, is the credit card provider him self, which gives the insurance to the transaction's. In fact the CLT method is a lot more safe then telephone transaction which are much more in use, and can easily replace them.

Another important side effect of the CLT method is that the credit card provider can allow cheaper insurance rates which will resolve in the decreasing of the credit card transaction's costs to both the consumer and the retailer.

### BRIEF DESCRIPTION OF THE DRAWING

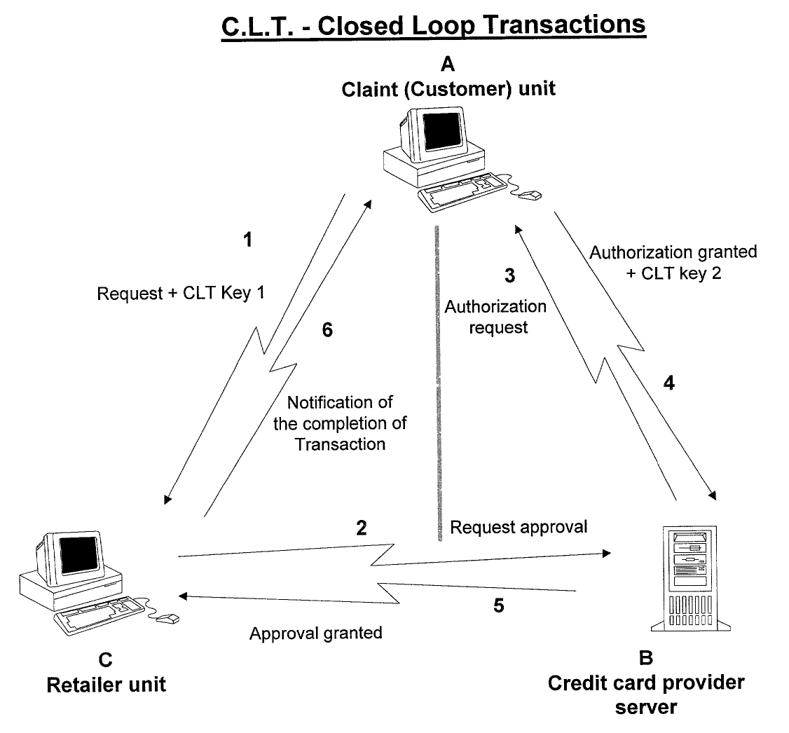

For a better understanding of the invention please refer to FIG. 1, which illustrates the form of the transaction procedure, one which the subject invention relates to.

The method is based on the full isolation between the following two routs:

The Customer (A)-Retailer(C) rout.

The Customer (A)-Secured money holder provider(B).

The method consists of the following 6 CLT step's Procedure:

The Customer (A) files a purchase request by sending his Credit card number and a special CLT number to the Retailer site(C).

The Retailer (C)sends the detail's to the Secured money holder provider (B) for approval.

The Secured money holder provider (B) sends an authorization request to the customer(A) in a special CLT E-mail address, known only to the Secured money holder provider and the customer, alone with a special CLT code, with the request detail's for approval.

The customer(A) sends his approval back to the Secured money holder provider (B)

The Secured money holder provider (B) sends the approval back to the Retailer (C).

the Retailer (C) informs the customer(A) about the completion of the Transaction. This isolation lives full control of the Customers details in the hands of the secured money holder provider, with out letting the retailer any access to that information.

### DETAILED DESCRIPTION

With reference to the figure, a method of providing safe commercial transactions via a network communications system is disclosed. As will be readily understood by one skilled in the art, the system on which the method resides, generally comprises a communications network, such as the internet, which has attached thereto a client unit A, a secured money holder provider (Credit card, bank, etc.) server unit B and a retailer (service/goods provider, etc.) unit C. The client unit A is usually a personal computer equipped with appropriate access software such as MICROSOFT EXPLORER, version 2.0+and NETSCAPE NAVIGATOR, version 1.2+, the secured host server B is a NETSCAPE commerce server that utilizes a 128 bit.

The method is based on the full isolation between the following two routs:

The Customer (A)-Business(C) rout.

The Customer (A)-Secured money holder providers) rout.

The method consists of the 6 CLT step's Procedure:

The procedure starts when a customer in the client unit A, files a form in the retailers network site, with an order form to be displayed thereon, typically created in Hypertext Markup Language (HTML), which includes various information fields which the user must complete in order to start the commercial transaction. It is contemplated that among these various information fields will be the terms of agreement and sum to be transferred, along with the clients credit card number(or part of them and CLT secure code(1), that stand for one of the two ‘keys’ needed for the completion of the transaction, and sends it directly to the port and process currently running the retailers server in a CGI form or equivalent.

When the retailer receives the information he sends it to the credit card providers secured network site where it is compared with the two relevant codes (credit card number(or part of them) and CLT secret code) through a look up table and if they comply, links them to the CLT E-mail address and special CLT code(2) along with the ID. Number, or the rest of the credit card specifics, which stand for the second key needed for completion of the transaction.

The credit card provider then sends the terms of the sale agreement between the customer and retailer, as they ware provided to him by the retailer, in E-mail to the CLT Electronic-mail address of the customer.

The customer is then required to fill his special CLT code(2) to close the loop. This information is returned to the credit card provider compared with the first ‘key’ and if they comply—send the authorization of the deal to the retailer. The retailer then sends back to the customer the indication for the successful completion of the transaction. It will be appreciated by those skilled in the art that this process of the 6 CLT steps occurs in micro seconds.

Accordingly all this process takes a few seconds until the Close Loop Transaction(CLT) is complete.

In this transaction method no one, hacker or any other people for that mater can complete a transaction because in the worst case he can have only one of the two ingredients (keys) needed for a Close Loop Transaction(CLT). The only link between those two keys remains in the credit card providers secured data base. Furthermore the retailer or any one else acting on his behalf will not be able to use the ‘half codes that he has, and therefore give the customer the assurance that his details wont be scattered around. No other method can assure that, in fact it makes network based transactions using Close Loop Transaction(CLT) safer and comfortable then Credit card transactions done through the phone.

In sum, the described invention has the advantages providing a user friendly, user transparent, and highly secured method of performing commercial transactions via a communications network.

The procedure described is only one way of implementing the CLT method and is not limited to using it in the specified way. The CLT method can also be implemented by using a third party in which the will holed the CLT codes information and will initiate the E-mail authorization request and receive the response. When using a third party the credit card detail's, or any other equivalent personal information, will be transformed to the Issuer or bank in two segments, each one consisting only half of the information. The first segment which consists of the first partial credit card number or equivalent will be received to the third party's web site, and will then be transmitted to the Issuer or bank, and immediately erased from the third party's servers. The second segment of information, which consists of the second partial credit card number or equivalent, will be received by E-mail from the customer, after the third party initiated a request to receive that information through a special E-mail address, given to the consumer by the third party upon registration. After receiving the second part of information, it will be sent to the Issuer of bank or equivalent, and then be erased from the third party's servers. The Issuer will then send the third party the transaction number, which will serve as a reference for each specific transaction. Further more, the CLT method described here by is not limited to the specified technologies, and can also be used in any other electronic way. For example when using Cellular phones or any other mobile device, and for any kind of communication protocol for both roots ( for example the e-mail can be replaced by SMS protocol etc.)

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention that is to be given the full breadth of the appended claims and any equivalent thereof.

What is claimed is:

1. In a network communication system comprising of a client unit, a retailer unit and a third party cash holder provider (for example a credit card provider), a method of providing a secured commercial transactions via the networked communications system comprises the steps of:
Providing a secured transaction method via the network communications system that protects the Customer's confidential information needed to complete a commercial transaction (for example credit card number and I.D. number), from reaching anyone but the cash holder provider, in particular from reaching the retailer.
Isolating the two different transaction routs, by dividing the Customer's confidential information needed to complete a commercial transaction, into two individual parts used in two different transaction routs, in a way that the completion of a commercial transaction would inquire both of them, and anyone of them is meaningless when stands on its own.
Protecting each of the two routs of commercial transaction referred to in the last fraise with a special CLT code known to the user and cash holder provider only.

2. The method as recited in claim 1, further comprising the steps of keeping sole control of the data needed for the completion of commercial transaction's exclusively in the hands of the cash holder provider, and by doing so, neutralizing the retailer from any contact to the customer's confidential information needed to complete a commercial transaction, and without holding that information in a third party's possession, which will increase the safety of the transaction.

3. The method as recited in claim 1, wherein the steps of providing a secure commercial transaction via a network communications system comprises the 6 CLT (Closed Loop Transactions) steps as recited in the description of the drawing.

4. The method as recited in claim 1, wherein the steps of providing a Closed Loop Transaction (referred to as CLT) provide a procedure which requires the authorization of the Customer for each individual commercial transaction, and is done by initiating an authorization request by the cash holder provider to the party which initiated the transaction (referred to as the customer), and requires the second set of codes to be filed, in a separate transformation root, by the customer, in order for the transaction to be complete.

5. The method as recited in claim 4, further emphasizes the enforcement of the need for authorization for each and every commercial transaction as it stands on its own.

6. In a network communication system comprising of a client unit, a retailer unit and a third party cash holder provider (for example a credit card provider), a method of providing a secured commercial transactions via the networked communications system comprises the steps of:
Providing a Close Loop Transaction (“CLT”) to provide the client with a secured network transaction method
maintaning the full commercial information in the hands of cash holder provider (for example a credit card provider) hands
Remaining with a complete isolation between the two following routs:
The Customer (A)-Retailer(C) rout.
The Customer (A)-Secured money holder provider(B).
